(19) United States
(12) Patent Application Publication
(10) Pub. No.: US 2012/0300273 A1
(43) Pub. Date: Nov. 29, 2012

(54) FLOATING VIRTUAL HOLOGRAM DISPLAY APPARATUS

(75) Inventor: CHIH-HSIUNG LIN, New Taipei City (TW)

(73) Assignee: Era Optoelectronics Inc., New Taipei City (TW)

(21) Appl. No.: 13/244,418

(22) Filed: Sep. 24, 2011

(30) Foreign Application Priority Data
May 23, 2011 (TW) 100117941

(51) Int. Cl. G03H 1/08; G03H 1/22

(52) U.S. Cl. 359/9; 359/32

(57) ABSTRACT

A floating virtual hologram display apparatus, includes a scanning mechanism, a diffractive optical element and a reconstruction light source thereof, where the scanning mechanism is installed with a scanning mirror. After a light beam emitted from the reconstruction light source passes through the diffractive optical element is diffracted by the diffractive optical element onto the scanning mirror, and then reflected by the scanning mirror, a hologram beam spot will be displayed in front of the scanning mirror; a floating virtual hologram is displayed in front of the scanning mirror after a position of the hologram beam spot is scanned and altered by the scanning mirror.

### BACKGROUND OF THE INVENTION

1. Field of the Invention

The present invention relates to a display apparatus, and more particularly to a floating display apparatus capable being used as a screen.

2. Description of Related Art

Taiwan publishing patent NO. 200951771 discloses an apparatus with a virtue touch screen, comprising a screen, an optical mechanism, and a detection module, where the optical mechanism has at least one optical lens. The picture on the screen is formed into a corresponding virtual screen image in a space through the optical mechanism by means of optical imaging principle. The detection module is used to detect whether a user touches the virtual screen image or not, detect and analyze the position of a contact position with the virtual screen, and transfer the position to a contact position with the screen corresponding thereto and signal commands so that the user can operate the digital contents displayed on the virtue screen with a touch control mode, thereby achieving the effect of operating the screen substantially instead of touching it directly. The above-mentioned Taiwan published patent still need use a general screen to provide the images needed for the virtual screen, and a traditional screen cannot be saved cannot be omitted to reduce the cost.

Referring to FIG. 1, a transparent diffractive optical element (DOE) 1 available in the market is made by using a light source to illuminate a body and a photosensitive substrate, and then forming interference fringes corresponding to the light emitted from the light source and the light reflected by the body on the substrate. When a reconstruction light source 2, which is the light source used while the DOE 1 is fabricated, is used to illuminate the DOE 1 on one face thereof, and a virtual hologram 3 corresponding to the body and floating in the air is then displayed at a position outside another face of the DOE 1 with a proper distance from it. But, the DOE 1 cannot be used to display a moving hologram floating in the air currently.

Referring to FIG. 2, a MEMS (Micro Electro Mechanical System) scanning mechanism made by combining a MEMS 41 with a micro scanning mirror (MSM) 42 is now available in the market. When a light beam corresponding to a fixed or moving image is emitted from a light source 43 and then projected on the MSM 42, the MSM 42 scans it from left to right and from top to down, and projects it to a scanning surface 5 such that a corresponding image can then be displayed. But, the MSH projector cannot project a floating moving hologram currently.

### SUMMARY OF THE INVENTION

To improve conventional floating hologram display apparatus, capable of having the effect of displaying a moving floating virtual hologram, the present invention is proposed.

The main object of the present invention is to provide a floating virtual hologram display apparatus, including a scanning mechanism, a DOE, and a reconstruction light source, utilizing the reconstruction light source to emit a light beam corresponding to an image; the light beam passes through the DOE onto a scanning mirror of the scanning mechanism to display a floating virtual hologram like a floating moving screen.

Another object of the present invention is to provide a floating virtual hologram display apparatus, utilizing a DOE and a plurality of reconstruction light sources corresponding to it. Light beams emitted from the plurality of reconstruction light sources pass through the DOE, and are then scanned and reflected by the scanning mirror of the scanning mechanism to display a floating three-dimensional virtual hologram.

### BRIEF DESCRIPTION OF THE DRAWINGS

The present invention can be more fully understood by reference to the following description and accompanying drawings, in which:

FIG. 1 is a schematic view of a conventional DOE, displaying a floating virtual hologram;

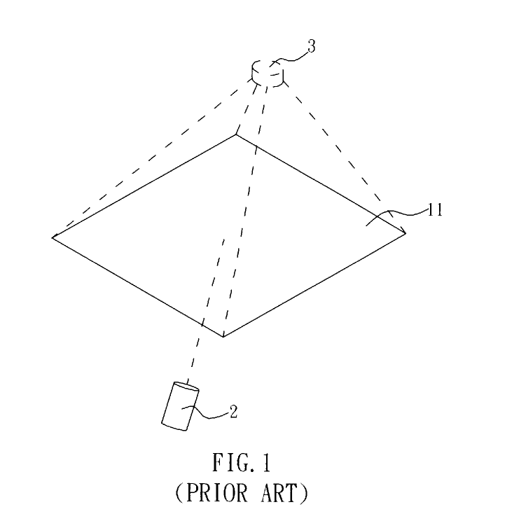

FIG. 2 is a schematic view of a conventional MSM projector, projecting an image;

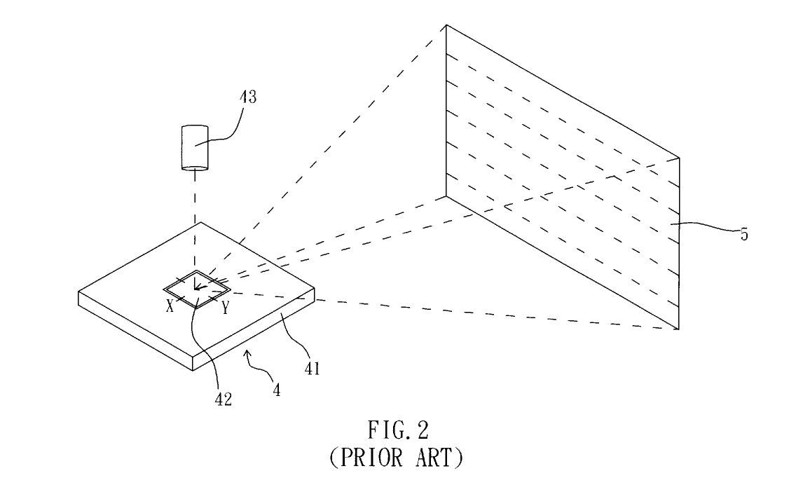

FIG. 3 is a schematic view of a floating virtual hologram display apparatus of a first preferred embodiment according to the present invention;

FIG. 4 is a schematic view of a floating virtual hologram display apparatus of a second preferred embodiment according to the present invention;

FIG. 5 is a schematic view of a floating virtual hologram display apparatus of a third preferred embodiment according to the present invention; and

FIG. 6 is a schematic view of a floating virtual hologram display apparatus of a fourth preferred embodiment according to the present invention;

### DETAILED DESCRIPTION OF THE PREFERRED EMBODIMENTS

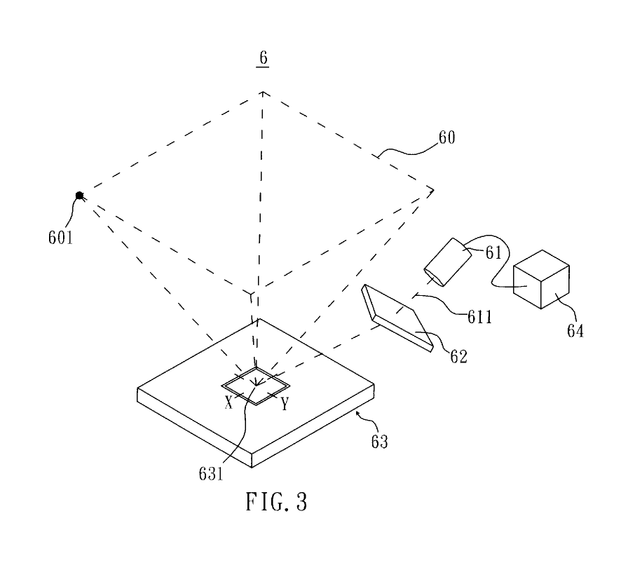

Referring to FIG. 3, a floating virtual hologram display apparatus 6 of a first preferred embodiment of the present invention includes a reconstruction light source 61, a DOE 62, a scanning mechanism 63 and an image signal processing unit 64, where the reconstruction light source 61 is electrically connected to the image signal processing unit 64. The scanning mechanism 63 is installed with a scanning mirror 631, and the scanning way of the scanning mirror 631 is taking a X-axis as a rotating axis scanning from left to right, and then taking a Y-axis as a rotating axis rotating down-up a small angle. Thereafter, the scanning mirror 631 takes the X-axis as a rotating axis rotating from right to left, and repeats the above-mentioned procedures scanning from left to right and up to down over and over again. The reconstruction light source 61 and the scanning mirror 631 are respectively positioned at one side of the DOE 62 where incident light is emitted and the other side of the DOE 62 where emergent light is projected out. After a light beam 611 emitted from the reconstruction light source 61 passes through the DOE 62, is diffracted by the DOE 62 onto the scanning mirror 631, and then reflected by the scanning mirror 631, a hologram beam spot 601 will be displayed in front of the scanning mirror 631. A floating virtual hologram 60 is displayed in front of the scanning mirror 631 to a human's vision through human persistence of vision after the position of the hologram beam spot 601 is scanned and altered by the scanning mirror 631 with a scanning speed of over 24 times per second to the whole picture of the virtual hologram 60. The floating virtual hologram 60 is allowed to display a variable virtual image like a floating moving screen by controlling the reconstruction light source 61 to emit bright, dark and different color of light corresponding to an image through the image signal processing unit 64.

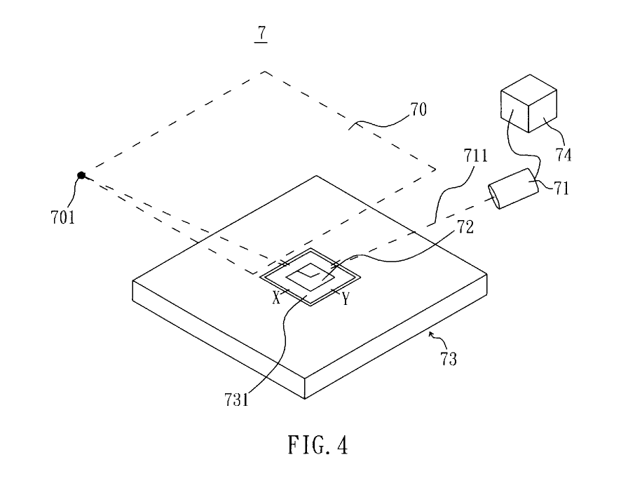

Referring to FIG. 4, a floating virtual hologram display apparatus 7 of a second preferred embodiment of the present invention includes a reconstruction light source 71, a DOE 72, a scanning mechanism 73 and an image signal processing unit 74, where the reconstruction light source 71 is electrically connected to the image signal processing unit 74, and the scanning mechanism 73 is installed with a scanning mirror 731. The present embodiment has approximately the same structure and functions as the first embodiment, except the DOE 72 of the present embodiment is attached to the scanning mirror 731. After a light beam 711 emitted from the reconstruction light source 71 passes through the DOE 72, is diffracted by the DOE 72 onto the scanning mirror 731, and then reflected by the scanning mirror 731, a hologram beam spot 701 will be displayed in front of the scanning mirror 731. A floating virtual hologram 70 is displayed in front of the scanning mirror 731 to a human's vision through human persistence of vision after the position of the hologram beam spot 701 is scanned and altered by the scanning mirror 731. The floating virtual hologram 70 is allowed to display a variable virtual image like a floating moving screen by controlling the reconstruction light source 71 to emit bright, dark and different color of light corresponding to an image through the image signal processing unit 74.

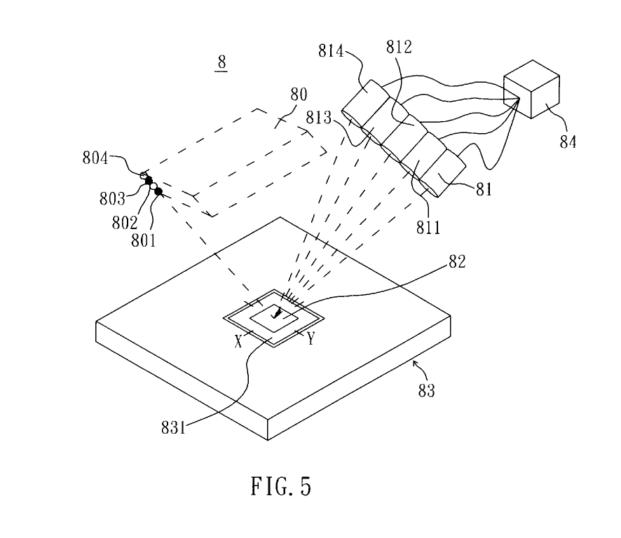

Referring to FIG. 5, a floating virtual hologram display apparatus 8 of a third preferred embodiment of the present invention includes a plurality of reconstruction light sources 811, 812, 813 and 814, a DOE 812, a scanning mechanism 813 and a image signal processing unit 84. The plurality of reconstruction light sources 811, 812, 813 and 814 are respectively electrically connected to the image signal processing unit 84, and the scanning mechanism 83 is installed with a scanning mirror 831. The present embodiment has approximately the same structure and functions as the second embodiment, except the DOE 82 of the present embodiment is operated in coordination with the plurality of reconstruction light sources 811, 812, 813 and 814. After light beams emitted from the plurality of reconstruction light sources 811, 812, 813 and 814 pass through the DOE 82, are diffracted by the DOE 82 onto the scanning mirror 831, and then reflected by the scanning mirror 831, a plurality of hologram beam spots 801, 802, 803 and 804 arranged in a line will be displayed in front of the scanning mirror 831. A floating three-dimensional virtual hologram 80 is displayed in front of the scanning mirror 831 to a human's vision through human persistence of vision after the positions of the plurality of reconstruction light sources 811, 812, 813 and 814 arranged in a line are scanned and altered. The floating three-dimensional virtual hologram 80 is allowed to display a variable virtual image like a floating moving screen by controlling the plurality of reconstruction light sources 811, 812, 813 and 814 to emit bright, dark and different color of light corresponding to a three-dimensional image through the image signal processing unit 84. The present embodiment may use one multi-wave length light source 81 stead of the plurality of reconstruction light sources 811, 812, 813 and 814. After four wavelengths of light beams emitted respectively from the multi-wavelength reconstruction light source 81 (equivalent to four different light beams emitted respectively from the four reconstruction light sources 811, 812, 813 and 814) pass through the DOE 82, are diffracted by the DOE 82 onto the scanning mirror 831, and then reflected by the scanning mirror 831, a plurality of hologram beam spots 801, 802, 803 and 804 arranged in a line will be displayed in front of the scanning mirror 831.

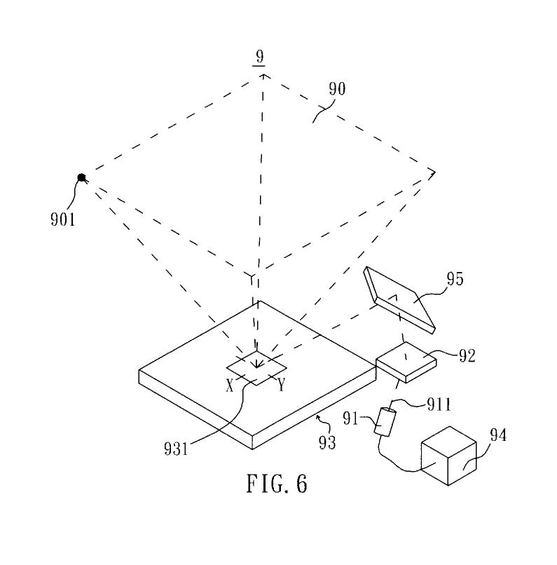

Referring to FIG. 6, a floating virtual hologram display apparatus 9 of a fourth preferred embodiment of the present invention includes a reconstruction light source 91, a DOE 92, a scanning mechanism 93, an image signal processing unit 94 and a reflection mirror 95, where the reconstruction light source 91 is electrically connected to the image signal processing unit 94, and the scanning mechanism 93 is installed with a scanning mirror 931. The present embodiment has approximately the same structure and functions as the first embodiment, except the light beam passing through the DOE 92 is reflected to the scanning mirror 931 by the reflection mirror 95 in the present embodiment so as to be convenient for the space arrangement of the whole structure of the floating virtual hologram display apparatus 9. After a light beam 911 emitted from the reconstruction light source 91 passes through the DOE 92, is diffracted by the DOE 92 and reflected by the reflection mirror 95 onto the scanning mirror 931, and then reflected by the scanning mirror 931, a hologram beam spot 901 will be displayed in front of the scanning mirror 931. A floating virtual hologram 90 is displayed in front of the scanning mirror 931 to a human's vision through human persistence of vision after the position of the hologram beam spot 901 is scanned and altered. The floating virtual hologram 90 is allowed to display a variable virtual image like a floating moving screen by controlling the reconstruction light source 91 to emit bright, dark and different color of light corresponding to an image through the image signal processing unit 94.

The scanning mechanism of each embodiment according to the present invention mentioned above may be a conventional MEMS (Micro Electro Mechanical System) scanning mechanism, the reconstruction light source may be a LED (light emitting diode) or a laser irradiation device, and the DOE may be other LCD (liquid crystal device capable of forming diffraction fringes or an OLED (Organic Electroluminesence Display).

The floating virtual hologram display apparatus further improves a conventional floating display apparatus, and has a function of displaying floating moving virtual hologram. Furthermore, it utilizes the reconstruction light source to emit a light beam corresponding to an image to pass through the DOE and then to the scanning mirror of the scanning mechanism, thereafter, the light beam is reflected and scanned by the scanning mirror to the front of the scanning mirror, thereby, displaying a floating virtual hologram corresponding to the image like a floating moving screen. Besides, it utilize one DOE and a plurality of reconstruction light sources corresponding thereto; light beams emitted from the plurality of reconstruction light sources pass through the DOE, and are then scanned and altered by the scanning mirror of the scanning mechanism to display a floating three-dimensional virtual hologram.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A floating virtual hologram display apparatus, comprising:
a diffractive optical element;
at least one reconstruction light source, being a reconstruction light source of said diffractive optical element; and
a scanning mechanism, installed with a scanning mirror;
wherein, after a light beam emitted from said reconstruction light source passes through said diffractive optical element, is diffracted by said diffractive optical element onto said scanning mirror, and then reflected by said scanning mirror, a hologram beam spot will be displayed in front of said scanning mirror; a floating virtual hologram is displayed in front of said scanning mirror after a position of said hologram beam spot is scanned and altered by said scanning mirror.

2. The floating virtual hologram display apparatus according to claim 1, wherein said diffractive optical element is attached to said scanning mirror.

3. The floating virtual hologram display apparatus according to claim 1, further comprising a reflection mirror, wherein said light beam passing through said diffractive optical mirror and diffracted by said diffractive optical mirror is further reflected by said reflection mirror onto said scanning mirror.

4. The floating virtual hologram display apparatus according to claim 1, further comprising an image signal processing unit, electrically connected to said reconstruction light source; said floating virtual hologram being allowed to display a variable virtual image by controlling said reconstruction light source to emit bright, dark and different color of light corresponding to an image through said image signal processing unit.

5. The floating virtual hologram display apparatus according to claim 2, further comprising an image signal processing unit, electrically connected to said reconstruction light source; said floating virtual hologram being allowed to display a variable virtual image by controlling said reconstruction light source to emit bright, dark and different color of light corresponding to an image through said image signal processing unit.

6. The floating virtual hologram display apparatus according to claim 3, further comprising an image signal processing unit, electrically connected to said reconstruction light source; said floating virtual hologram being allowed to display a variable virtual image by controlling said reconstruction light source to emit bright, dark and different color of light corresponding to an image through said image signal processing unit.

7. The floating virtual hologram display apparatus according to claim 1, comprising a plurality of reconstruction light sources; wherein said plurality of reconstruction light sources respectively emit a light beam, allowing a plurality of hologram beam spots arranged in a line to be displayed in front of said scanning mirror, a three-dimensional virtual hologram is displayed in front of said scanning mirror after positions of said plurality of hologram beam spots arranged in a line are scanned and altered.

8. The floating virtual hologram display apparatus according to claim 7, further comprising an image signal processing unit, electrically connected to said plurality of reconstruction light sources; said floating three-dimensional virtual hologram being allowed to display a variable three-dimensional virtual image by controlling said plurality of reconstruction light sources to emit bright, dark and different color of light corresponding to a three-dimensional image through said image signal processing unit.

9. The floating virtual hologram display apparatus according to claim 1, wherein said reconstruction light source is a multi-wavelength reconstruction light source; said multi-wavelength light source emit light with a variety of wavelengths, allowing a plurality of hologram beam spots arranged in a line to be displayed in front of said scanning mirror, a three-dimensional virtual hologram is displayed in front of said scanning mirror after positions of said plurality of hologram beam spots arranged in a line are scanned and altered.

10. The floating virtual hologram display apparatus according to any one of claim 1, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.

11. The floating virtual hologram display apparatus according to any one of claim 2, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.

12. The floating virtual hologram display apparatus according to any one of claims 3, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.

13. The floating virtual hologram display apparatus according to any one of claim 4, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.

14. The floating virtual hologram display apparatus according to any one of claim 5, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.

15. The floating virtual hologram display apparatus according to any one of claim 6, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.

16. The floating virtual hologram display apparatus according to any one of claim 7, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.

17. The floating virtual hologram display apparatus according to any one of claim 8, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.

18. The floating virtual hologram display apparatus according to any one of claim 9, wherein said scanning mechanism is a micro electro mechanical system scanning mechanism, said reconstruction light source is one selected from a light emitting diode and laser irradiation device, and said diffractive optical element is one selected from a liquid crystal display and an organic electroluminesence display generating diffraction fringes.
